(19) United States
(12) Patent Application Publication
(10) Pub. No.: US 2024/0371179 A1
(43) Pub. Date: Nov. 7, 2024

(54) DETECTING INDIVIDUAL FREE MARKED TARGET AREAS FROM IMAGES OF A CAMERA SYSTEM OF A MOVEMENT DEVICE

(71) Applicant: Continental Autonomous Mobility Germany GmbH, Ingolstadt (DE)

(72) Inventors: Thomas Winkler, Lindau (DE); Ferdinand Kaiser, Ulm (DE); Christoph Brand, Kressbronn (DE)

(73) Assignee: Continental Autonomous Mobility Germany GmbH, Ingolstadt (DE)

(21) Appl. No.: 18/556,666

(22) PCT Filed: Apr. 19, 2022
(86) PCT No.: PCT/DE2022/200073

§ 371 Date: Oct. 21, 2023

(30) Foreign Application Priority Data
Apr. 22, 2021 (DE) 10 2021 204 030.6

(51) Int. Cl. G06V 20/58; G06T 7/12; G06V 10/764

(52) U.S. Cl. CPC G06V 20/586; G06T 7/12; G06V 10/764

(57) ABSTRACT

The present disclosure relates to a method and a device for detecting individual free marked target areas such as, e.g., parking/landing/docking places, from images of a camera system) of a movement device by means of a machine learning system, and to a method for training the machine learning system. The method for segmenting and identifying individual free marked target areas includes the steps of: capturing at least one image of the environment of the movement device by means of the camera system; segmenting the individual free marked target areas from the at least one image by means of a machine learning system trained; and outputting, to a control unit, a first segment which corresponds to the individual free marked target area and second segments of at least one additional class of the captured environment of the movement device.

### CROSS-REFERENCE TO RELATED APPLICATIONS

The present application is a National Stage Application under 35 U.S.C. § 371 of International Patent Application No. PCT/DE2022/200073 filed on Apr. 19, 2022, and claims priority from German Patent Application No. 10 2021 204 030.6 filed on Apr. 22, 2021, in the German Patent and Trademark Office, the disclosures of which are herein incorporated by reference in their entireties.

### TECHNICAL FIELD

The invention relates to a method and a device for detecting individual free marked target areas such as, e.g., parking/landing/docking places, from images of a camera system of a movement device by means of a machine learning system, and to a method for training the machine learning system.

### BACKGROUND

EP 2486513 B1 discloses a driver assistance system for a motor vehicle having a camera for recognizing road markings; according to the invention, an apparatus is provided for recognizing a parked or stopped mode of the vehicle. In addition, a controller receives image data of the surroundings of the vehicle from the camera when the vehicle is in the parked or stopped mode and analyzes the image data with respect to road markings displaying no-parking and/or no-stopping spots, wherein the controller actuates a signaling device such that the signaling device outputs a warning message in the event that a road marking displaying a no-parking spot or a no-stopping spot is detected in the surroundings of the stopped or parked vehicle. Instead of one camera, it is also possible to utilize multiple cameras or image recording units with different viewing directions (e.g., regions to the side of the vehicle) and installation positions (e.g., in the outside rearview mirrors).

DE 102018214915 A1 discloses a system and a method for a vehicle for recognizing a parking space in the direction of travel. The space must have at least a predefined length and/or at least a predefined width corresponding to the vehicle length or width. A sensor is set up to determine an outer contour of boundaries. The sensor can be an individual sensor, e.g., a camera, or a plurality of sensors, e.g., multiple cameras, or multiple kinds of sensors, for example a camera and a radar sensor.

A map is set up to assign the outer contour of the boundaries to a location on the map. An assigning module is set up to arrange a rectangle having the predefined length and the predefined width in the space between the boundaries so that, if the rectangle can be arranged in the space, the identified space is suitable for accommodating the vehicle. The boundaries can comprise road markings.

Road markings are, for example, hatched areas or crosswalks or parking space boundaries. In some embodiments, road markings can be considered in a different manner to the outer contour. For example, a space which is large enough in terms of the outer contours, but which is no longer large enough when the parking space boundaries are taken into consideration, could require an “Ignore parking space boundaries” decision from a driver of the vehicle.

EP 3731138 A1 discloses an image processing device and a vehicle camera system with which corner markings on one end of a parking space marking can be recognized via edge recognition. A provisional parking frame is then set and verified on the basis of the recognized corner markings. As a result, free parking spaces can be identified.

### SUMMARY

It is an object of the present disclosure to provide improved solutions for identifying free target areas in images of a camera system.

The solution is the subject-matter of the independent claims. Advantageous further developments are the subject-matter of the dependent claims.

The starting point for the development of the solution is that problems have been observed with possible concepts in the field of parking automation. One possibility involves using algorithms for detecting parking spaces on the basis of separate detection of parking lines and free space. In the first step, a top-view image is produced using static camera calibration and the flat world assumption in order to transform curved lines (fisheye domain) into straight lines (virtual pinhole camera). Parking lines are recognized on the image by means of classic image processing (e.g., Hough Transform), based on which potential parking spaces are detected in a model-based manner. Additionally, free space recognition is extracted via a second algorithm (e.g., occupancy grid). With the aid of this second item of information, a free parking space may then be recognized.

The central prerequisites of this possible concept are that the camera is calibrated correctly and that the environment is flat. If the camera is not calibrated correctly, e.g., as a result of the vehicle being loaded on one side, or the environment not being flat (parking on inclined areas), the quality of the top-view image and, therefore, the quality of the parking space recognition reduces. Additionally, a very sparse object-based item of point cloud information is used, as a general rule, for the free space recognition, which only supplies very little information for homogeneous surfaces such as a pavement surface and the function may only be made possible based on rigid assumptions.

A novel solution concept is therefore pursued within the framework of the present disclosure.

A method according to the present disclosure for training a machine learning system for segmenting and identifying individual free marked target areas such as, e.g., parking spaces for vehicles, landing places for airplanes or drones, docking places for spacecraft or robots, from an image of an environment-capturing camera system of a movement device within the framework of a semantic segmentation of the image, provides for the following: training data, which includes training input images and assigned training target segmentations, are provided. Parameters of the machine learning system are adjusted by means of the training data such that the machine learning system, on inputting the training input images, produces output data which are similar to the training target segmentations. “Similar” may mean that the differences between the produced output data and the training target segmentations are small. The adjustment may be effected by means of a minimization of a function which mathematically describes these differences. The training target segmentations include at least one first segment (e.g., position and extent or size of the segment), which corresponds to the individual free marked target area. A first segment should in each case correspond to exactly one individual (i.e., one instance of a) free marked target area. “Marked” may, for example, mean that the target area is marked by means of a boundary line or may otherwise be optically recognized as a target area. The training target segmentations include at least one second segment which corresponds to at least one additional class of the captured environment of the movement device. In most cases, multiple second segments which correspond to different classes may be present.

The machine learning system includes, for example, an artificial neural network, the parameters (e.g., weights) of which are adjusted by means of the training data.

In one embodiment, the training target segmentations indicate the type of a first segment. If the target area corresponds to a parking space, a disabled parking space, a parking space reserved for women, an electric vehicle parking space and/or a parking space for families with children may, for example, be indicated as the type of parking space.

According to one variant of an embodiment, the second segments include objects in the environment of the movement device and at least one item of class information of the object is indicated. Examples of class information of the second (semantic) segments are: a built-up area, signs, plants, vehicles, two-wheeled vehicles, trailers, containers, people, animals, etc. Markings on the ground may also be provided as objects, e.g., lane boundary lines, parking space boundary lines 52, arrows on the ground, traffic symbols on the ground, stop lines, etc.

In one embodiment, the camera system includes a camera having a fisheye lens. The fisheye lens camera may have a capturing angle of more than 180°, e.g., approximately 195°. The training input images are then images of the fisheye lens camera. These may be used without rectification (correction of the optical imaging properties of the fisheye lens). In this case, the training target segmentations also correspond to the fisheye imaging. This embodiment offers the advantage that a segmentation on the basis of fisheye lens images makes the method very robust against rotations of the camera system.

A computer-implemented method according to the present disclosure for segmenting and identifying individual free marked target areas from images of a camera system of a movement device includes the steps of:
capturing at least one image of the environment of the movement device by means of the camera system;
segmenting the individual free marked target areas from the at least one image by means of a machine learning system trained according to one of the preceding claims;
outputting, to a control unit, a first segment which corresponds to the (identified) individual free marked target area, and second segments of at least one additional class of the captured environment of the movement device. On the basis of the received segments, the control unit may support a movement of the movement device to the free target area or may perform the movement autonomously, i.e., fully automatically. To this end, the segments may be translated into information regarding the geometry of the real environment, for example via a precisely calibrated camera system. It may also be assumed that the environmental surface on which the movement device is located is substantially planar. Some camera systems offer particular possibilities of 3D reconstruction of the captured environment, e.g., stereo methods via triangulation in the case of two individual cameras which have an overlapping field of view.

In one embodiment, the camera system may include multiple (fisheye) cameras which are arranged and designed such that a 360° capturing of the environment of the movement device is affected.

According to one variant of an embodiment, the control unit may provide support for moving the movement device to the free target area by means of an optical display on the basis of the output segments. For example, the environment of the movement device may be visualized and the free target area may be highlighted visually. This visualization may be displayed on a display of the movement device.

In one embodiment, the control unit provides support for moving the movement device to the free target area on the basis of the output segments by means of audible or haptic measures or measures partially controlling the movement of the movement device (e.g., steering or braking assistance during a parking process).

According to one variant of an embodiment, the control unit moves the movement device to the free target area fully automatically on the basis of the output segments, e.g., autonomous or fully automatic parking.

In one embodiment, the control unit transmits an item of information for locating the free marked target areas (wirelessly) to an infrastructure apparatus external to the movement device on the basis of the output segments which correspond to individual free marked target areas. The infrastructure apparatus may, for example, relate to a control center of a parking garage or a backbone (cloud) of a telematics provider. As a result, parking areas which are currently free may be marked on a map and offered to other road users via V2X.

According to one variant of an embodiment, the movement means is a vehicle and the free marked target area is a free parking space or an area for inductive charging of an electric vehicle (in this case). As a result, the electric vehicle may be positioned precisely over the inductive charging area (the inductive charging pad).

A further subject-matter of the present disclosure relates to a device or a system for segmenting and identifying individual free marked target areas from images of a camera system of a movement device.

The device includes
an input unit which is configured to receive at least one image of the camera system;
a data processing unit which is configured to execute a method according to the present disclosure; and
an output unit which is configured to output, to a control unit, a first segment, which corresponds to the individual free marked target area; and second segments of at least one additional class of the captured environment of the movement device.

The device or the data processing unit may in particular include a microcontroller or processor, a central processing unit (CPU), a graphics processing unit (GPU), a digital signal processor (DSP), an ASIC (Application Specific Integrated Circuit), a FPGA (Field Programmable Gate Array) and so forth as well as software for performing the corresponding method steps.

In addition, the present disclosure relates to a movement means which includes the camera system, the control unit and a device according to the present disclosure.

Furthermore, the present disclosure relates to a computer program element which, when a data processing unit is programmed therewith, instructs the data processing unit to perform a method for segmenting and identifying individual free marked target areas from images of a camera system of a movement device.

Furthermore, the present disclosure relates to a computer-readable storage medium on which such a program element is stored.

The present disclosure may consequently be implemented in digital electronic circuits, computer hardware, firmware or software.

In other words, the present disclosure makes it possible to detect and vectorize instantiated, free parking spaces in a direct, highly precise manner by using neural networks, in order to automate automatic parking processes more effectively. Both labeling and detection, directly on fisheye (195°) images, without additional (top-view) rectification, improve the accuracy of the shape of free marked target areas.

One aspect relates to the direct detection of free parking spaces by means of semantic segmentation in the fisheye domain. To this end, an existing list of detectable classes (curb, street, person, car, road marking) may be extended by the “parking space” class, label data produced and the neural network trained on the basis of appropriate training data.

The region between the parking lines is detected and output directly by

the algorithm. A separate detection of boundary parking lines may take place within the framework of the road marking class.

In the last step, the point clouds are merged into clusters in order to provide the subsequent environment model with a geometric description in the form of a polygon and to make possible trajectory planning.

Additionally, height information, which is indirectly derived from the classification of the static and dynamic objects, may be output in order to support trajectory planning/parking function.

Significant advantages of the present disclosure are seen in the fact that the direct parking space detection simplifies known methods since, in the case of known methods, the parking space has to first be formed, in a manner which is complex and error-prone, by means of existing parking markers, including manual adjustments in terms of the high variability of the line markings around the world (white lines, red paving stones, etc.).

By contrast, in the case of direct parking space detection, the parking area is detected as such directly by means of the neural network which is being used, and may be trained for, and adjusted to, all of the possible variations around the world with manageable outlay (recording, labeling, tracking), by means of training.

This approach also deals directly with those situations which would make parking impossible (people, objects in the parking area), since only regions which are actually free are used as free parking areas during the training.

The areas of application of the present disclosure concern all kinds of marked target areas which have to be headed for in a highly precise manner, e.g., automated induction charging areas for electric vehicles, helipads, drop zones for automated parcel deliveries, etc.

### BRIEF DESCRIPTION OF THE DRAWINGS

Example embodiments and figures are described in greater detail below, wherein:

FIG. 1 shows a first schematic representation of a device according to the present disclosure in one configuration;

FIG. 2 shows a second schematic representation of a device according to the present disclosure in one configuration in a vehicle;

FIG. 3 show a system having a neural network for detecting individual free marked target areas; and

FIG. 4 shows an environmental scenario in which individual free marked parking spaces are detected.

### DETAILED DESCRIPTION

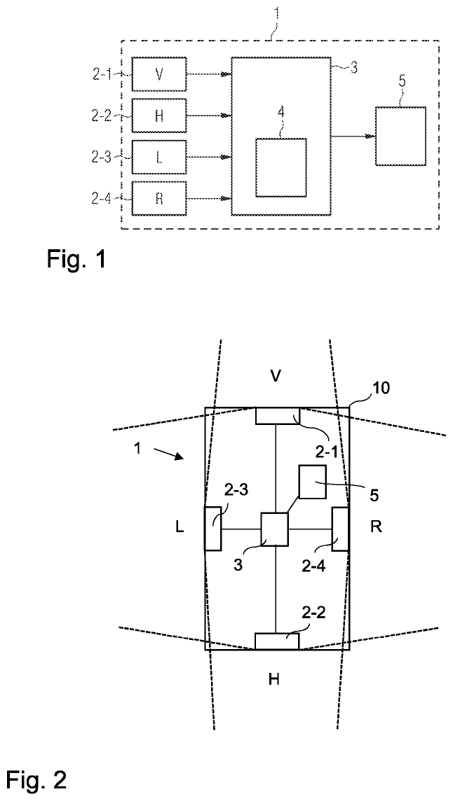

As can be seen from FIG. 1, a device 1 according to the present disclosure for detecting individual free marked target areas from image data from multiple cameras of a surround-view camera system may have multiple units or circuit components. In the case of the example embodiment depicted in FIG. 1, the device 1 has multiple (individual) cameras 2-i which each produce camera images or video data. In the case of the example embodiment depicted in FIG. 1, the device 1 has four cameras 2-i for producing camera images. The number of the cameras 2-i may vary for different applications. The device 1 according to the present disclosure has at least two cameras for producing camera images.

The device 1 contains a data processing unit 3 which processes the camera images produced by the cameras 2-i. For example, the camera images may be stitched together to form an overall image. As depicted in FIG. 1, the data processing unit 3 has an artificial neural network 4. The artificial neural network 4 was trained by means of a machine learning method to the effect that it semantically segments input image data (Ini) of the cameras (2-i) and thereby instantiates free marked target areas such as, e.g., free parking spaces with a boundary marking. The results of the semantic segmentation are output by the image processing unit 3 to a control unit 5. The control unit may support a movement of the movement device to a detected free target area or control an autonomous movement of the movement device to the target area.

FIG. 2 shows a further schematic representation of a device 1 according to the present disclosure in a configuration. The device 1 depicted in FIG. 2 is utilized in a surround-view system of a vehicle 10, in particular of a car or of a truck. In this case, the four different cameras 2-1, 2-2, 2-3, 2-4 may be located on different sides of the vehicle 10 and have corresponding fields of view (dashed lines) in front of V, behind H, to the left of L and to the right of R of the vehicle(s) 10. For example, the first vehicle camera 2-1 is located on a front side of the vehicle 10, the second vehicle camera 2-2 is located on a back side of the vehicle 10, the third vehicle camera 2-3 is located on the left side of the vehicle 10 and the fourth vehicle camera 2-4 is located on the right side of the vehicle 10. In the case of one possible embodiment, the vehicle cameras 2-i are so-called fisheye cameras which have a viewing angle of at least 195°. In the case of one possible embodiment, the vehicle cameras 2-i may transfer the camera images or camera image frames or video data via an Ethernet connection to the data processing unit 3. The data processing unit 3 may produce a composite surround-view camera image from the camera images of the vehicle cameras 2-i, which may be displayed to the driver and/or a passenger via a control unit 5 and a display. Free parking spaces may be highlighted on the display. The displaying process is one possible way of supporting the driver as he heads for the marked parking area. In the case of (partially) automated vehicles, the control unit 5 may (partially) take over control of the vehicle (accelerating, braking, changing the direction of travel between forwards/backwards, steering), so that the vehicle drives (partially) autonomously into a free parking space.

This embodiment corresponds to a surround view-based “environment perception” which makes possible instantiated parking area extraction.

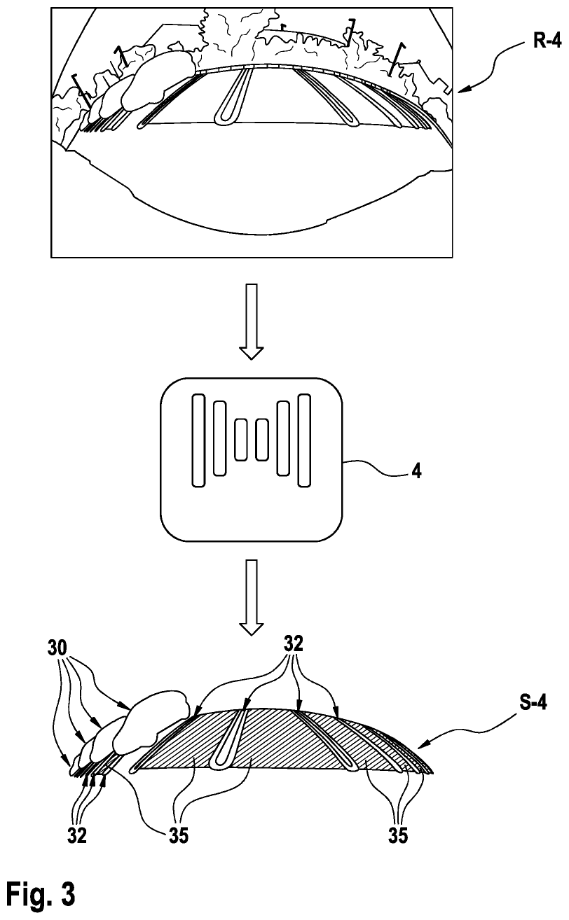

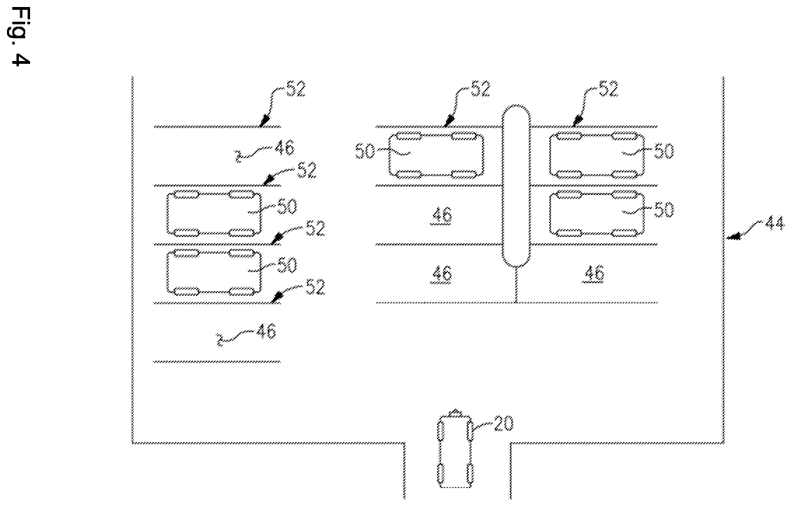

FIG. 3 shows a system having an artificial neural network 4 for semantic segmentation and identification of individual free marked target areas from camera images.

An image (R-4) of a fisheye lens camera is depicted very schematically in the upper part, in which, e.g., a parking lot having marking lines, vehicles, road surfaces as well as, in the background, street lamps, trees and bushes and buildings may be seen. Within the framework of the training, the artificial neural network 4 learns to assign a segmentation (S-4) to this image, as depicted in extracts in the lower part of FIG. 3. Here, classes are assigned to each pixel by means of a semantic segmentation. In particular, object classes such as, e.g., the vehicles 30 parked on the left-hand side are important. Parking marking lines 32 may also be assigned within the framework of the semantic segmentation. On the other hand, the surface of a parking space does not necessarily differ from the road surface. However, the artificial neural network 4 is trained to the effect that it identifies individual (instances of) free marked parking spaces 35 within the framework of the segmentation. In the present case, multiple individual free parking spaces 35 are located to the right of the vehicle 30 parked furthest to the right and an individual free parking space 35 is located to the left of the vehicle 30. Following the conclusion of the training, the artificial neural network assigns a corresponding segmentation having identified parking space instances to a previously unknown fisheye camera image.

FIG. 4 schematically shows a bird's-eye view of a parking lot 44, for example in front of a supermarket or on one level of a parking garage. The parking lot 44 has marking lines 52 which define (individual) parking spaces 46. The ego-vehicle 20 arrives at the parking lot 44 and needs a free parking space 46. Other vehicles 50 are already parked in individual marked parking spaces. Ideally, the other vehicles 50 are located within the lines 52 of the parking spaces in which they are parked. The ego-vehicle 20 records images (R-4) with at least one (fisheye lens) camera (2-1; 2-2; 2-3; 2-4) while it is moving, as a result of which the parking lot 44, the marking lines 52 and the additional vehicles 50 are captured.

The images (R-4) of the vehicle camera (2-1; 2-2; 2-3; 2-4) are processed by means of a data processing unit 3. The trained artificial neural network 4 of the data processing unit 3 establishes segments from the images which are assigned to a semantic class.

Examples of classes of semantic segments are, for example: objects, such as e.g.: a built-up area, signs, plants, vehicles 50, two-wheeled vehicles, trailers, containers, people, animals and markings on the ground, e.g., lane boundary lines, parking space boundary lines 52, arrows on the ground, traffic symbols on the ground, stop lines, etc.

By virtue of the training explained with reference to FIG. 3, the artificial neural network is able to identify individual free parking spaces 46 within markings 52 within the framework of the semantic segmentation. As a result, the ego-vehicle 20 may automatically park in a free parking space 46.

1. A method for training a machine learning system for segmenting and identifying individual free marked target areas from an image of an environment-capturing camera system of a movement device within a framework of a semantic segmentation of the image, wherein training data, which comprise training input images and assigned training target segmentations, are provided, and parameters of the machine learning system are adjusted by means of the training data such that the machine learning system, on inputting the training input images, produces output data which are similar to the training target segmentations,
wherein the training target segmentations comprise:
a first segment which corresponds to the individual free marked target areas, and
at least one second segment of at least one additional class of the a captured environment of the movement device.

2. The method according to claim 1, wherein the training target segmentations additionally indicate a type of a first segment.

3. The method according to claim 1, wherein the at least one second segments comprises objects and at least one item of class information of the objects.

4. The method according to claim 1, wherein the camera system comprises a camera having a fisheye lens, and wherein the training input images are images from the fisheye lens camera.

5. A method for segmenting and identifying individual free marked target areas from images of a camera system of a movement device, the method comprising:
capturing at least one image of an environment of the movement device by the camera system;
segmenting the individual free marked target areas from the at least one image by a machine learning system trained according to claim 1,
outputting, to a control unit, a first segment which corresponds to the individual free marked target area, and second segments of at least one additional class of the captured environment of the movement device.

6. The method according to claim 5, wherein the camera system comprises at least one camera having a fisheye lens.

7. The method according to claim 6, wherein the segmenting is performed on the at least one image from the fisheye lens camera.

8. The method according to claim 6, wherein the camera system comprises multiple cameras which are arranged and configured such that a 360° capturing of the environment of the movement device is affected.

9. The method according to claim 5, wherein the control unit provides support for moving the movement device to the free target area by an optical display on the basis of the output segments.

10. The method according to claim 5, wherein the control unit provides support for moving the movement device to the free target area by audible or haptic measures or measures partially controlling the movement of the movement device on the basis of the output segments.

11. The method according to claim 5, wherein the control unit moves the movement device to the free target area fully automatically on the basis of the output segments.

12. The method according to claim 5, wherein the control unit transmits an item of information for locating the free marked target areas to an infrastructure apparatus external to the movement device on the basis of the output segments which correspond to individual free marked target areas.

13. The method according to claim 5, wherein the movement device is a vehicle and the free marked target area is a free parking space or an area for inductive charging of an electric vehicle.

14. A device for segmenting and identifying individual free marked target areas from images of a camera system of a movement device, the device comprising:
an input unit which is configured to receive at least one image;
a data processing unit comprising a processor which is configured to execute the method according to claim 5; and to output
to a control unit a first segment which corresponds to the individual free marked target area and second segments of at least one additional class of the captured environment of the movement device.

15. The movement device, comprising the camera system, the control unit and the device according to claim 14.
